(19) United States
(12) Patent Application Publication
(10) Pub. No.: US 2011/0125765 A1
(43) Pub. Date: May 26, 2011

(54) METHOD AND APPARATUS FOR UPDATING MEDIA PROFILE

(75) Inventor: Apaar Tuli, Helsinki (FI)

(73) Assignee: Nokia Corporation, Espoo (FI)

(21) Appl. No.: 12/626,504

(22) Filed: Nov. 25, 2009

(51) Int. Cl. G06F 15/16; G06F 17/30

(52) U.S. Cl. 707/751; 709/217; 707/E17.014

(57) ABSTRACT

An approach is provided for updating a media profile. The social media service receives a request, from a device, to update a content object, wherein the content object includes a content playlist for expressing a content preference of a user of the device. Then, the social media service, in response to the request, automatically retrieves information related to the content preference from the device or another device associated with the user. Next, the social media service selects one or more content items to include in the content playlist based on the retrieved content preference information.

### BACKGROUND

Service providers and device manufacturers are continually challenged to deliver value and convenience to consumers by, for example, providing compelling network services and advancing the underlying technologies. One area of interest has been the development of services and technologies for sharing content (e.g., music) and related information across a variety of platforms (e.g., mobiles devices, fixed terminals) and scenarios (e.g., location of devices, connectivity capabilities, etc.). In particular, service providers and device manufacturers are developing software objects (e.g., content objects) that can be embedded in a web page, email, or other medium for presentation to users. In one use, the content objects can share or present content that is representative of user's preferences or an image the user wants to project to others who view the content object. However, such content objects generally rely on the user manually entering preference and profile information to determine what content is to be shown in the content object. This manual entry process can be quite cumbersome and time-consuming because information about the user interest or preferences in media may be quite extensive to enter, hard to locate, or just too inconvenient for the user to enter. As a result, service providers and device manufacturers face significant technical challenges to providing a process for populating the profile of a content object for sharing content interests.

### SOME EXAMPLE EMBODIMENTS

Therefore, there is a need for an approach for efficiently and automatically updating a media profile of a content object.

According to one embodiment, a method comprises receiving a request, from a device, to update a content object, wherein the content object includes a content playlist for expressing a content preference of a user of the device. The method also comprises, in response to the request, automatically retrieving information related to the content preference from the device or another device associated with the user. The method further comprises selecting one or more content items to include in the content playlist based on the retrieved content preference information.

According to another embodiment, an apparatus comprising at least one processor, and at least one memory including computer program code, the at least one memory and the computer program code configured to, with the at least one processor, cause, at least in part, the apparatus to receive a request, from a device, to update a content object, wherein the content object includes a content playlist for expressing a content preference of a user of the device. The apparatus is also caused, in response to the request, to automatically retrieve information related to the content preference from the device or another device associated with the user. The apparatus is further caused to select one or more content items to include in the content playlist based on the retrieved content preference information.

According to another embodiment, a computer-readable storage medium carrying one or more sequences of one or more instructions which, when executed by one or more processors, cause, at least in part, an apparatus to receive a request, from a device, to update a content object, wherein the content object includes a content playlist for expressing a content preference of a user of the device. The apparatus is also caused, in response to the request, to automatically retrieve information related to the content preference from the device or another device associated with the user. The apparatus is further caused to select one or more content items to include in the content playlist based on the retrieved content preference information.

According to another embodiment, an apparatus comprises means for receiving a request, from a device, to update a content object, wherein the content object includes a content playlist for expressing a content preference of a user of the device. The apparatus also comprises means for, in response to the request, automatically retrieving information related to the content preference from the device or another device associated with the user. The apparatus further comprises means for selecting one or more content items to include in the content playlist based on the retrieved content preference information.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of updating a media profile, according to one embodiment;

FIG. 2 is a diagram of the components of a content object, according to one embodiment;

FIG. 3 is a diagram of the components of the service application, according to one embodiment;

FIG. 4 is a flowchart of a process for updating a media profile, according to one embodiment;

FIG. 5 is a flowchart of a process for updating a media profile, according to one embodiment;

FIG. 6 is a flowchart of a process for updating a media profile, according to one embodiment;

FIGS. 7A-7C are diagrams of user interfaces utilized in the processes of FIG. 5, according to various embodiments;

FIGS. 8A-8B are diagrams of user interfaces utilized in the processes of FIG. 5, according to various embodiments;

FIG. 9 is a diagram of components of a content object service, according to one embodiment;

FIG. 10 is a diagram of an example web page with multiple content objects embedded thereon, according to an embodiment;

FIG. 11 is a flowchart of a process in a web server to use content objects, according to one embodiment;

FIG. 12 is a flowchart of a process at a content object or content object service to provide and render shared content, according to one embodiment;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for updating a media profile associated with a content object are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, a content object is a software object that can be embedded in a web page or email or other message for presentation to one or more users. Software objects are self-contained collections of data and methods and used, for example, in object-oriented programming (OOP). In some embodiments, a locket provides a graphical user interface (GUI). In other embodiments, a content object is also known as a content locket. Additionally, in certain embodiments, a widget may also be a content object. By way of example, widgets are light-weight applications based on standard web technologies (e.g., web runtime (WRT)—a web application runtime environment included in many browsers), that serve as frontends or clients to web-based or other content. Content objects provide a convenient means for presenting information and accessing services.

Although several embodiments of the invention are discussed with respect to music sharing using a web browser containing one or more embedded content objects, it is recognized by one of ordinary skill in the art that the embodiments of the inventions have applicability to any type of content rendering, e.g., music or video playback or streaming, games playing, image or map displaying, radio or television content broadcasting or streaming, involving any device, e.g., wired and wireless local device or both local and remote wired or wireless devices, capable of rendering content, or capable of communication with such a device, using any application that allows objects to be embedded, such a standard web browser, a standard email client, a standard instant messaging client, and a standard file transfer protocol (FTP) client. As used herein, content or media includes, for example, digital sound, songs, digital images, digital games, digital maps, point of interest information, digital videos, such as music videos, news clips and theatrical videos, advertisements, program files or objects, any other digital media or content, or any combination thereof. The term rendering indicates any method for presenting the content to a human user, including playing music through speakers, displaying images on a screen or in a projection or on tangible media such as photographic or plain paper, showing videos on a suitable display device with sound, graphing game or map data, or any other term of art for presentation, or any combination thereof. In many illustrated embodiments, a player is an example of a rendering module. A playlist is information about content rendered on one or more players in response to input by a user, and is associated with that user. A play history is information about the time sequence of content rendered on one or more players in response to input by a user, and is associated with that user.

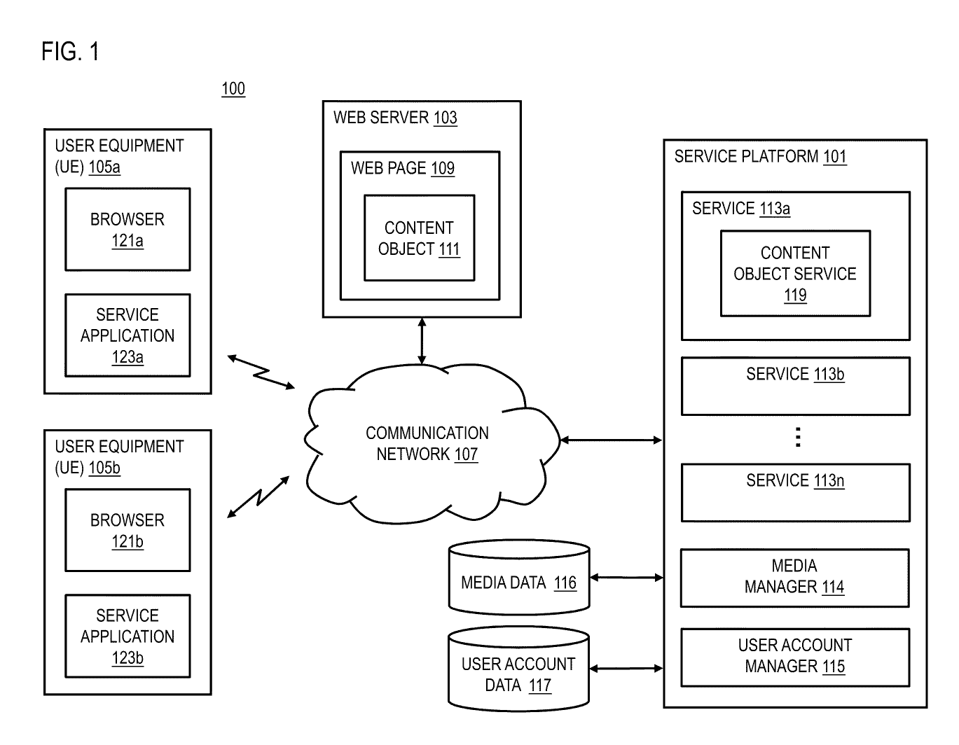

FIG. 1 is a diagram of a system capable of updating a media profile, according to one embodiment. As discussed previously, social networking services (e.g., a social music service) have emerged as a popular method to allow users to interact with other users and build a community to share similar interests over a network such as the Internet. It is noted that social networking over the Internet is often based on information manually provided by the users themselves. For example, a user can set up a profile on the social network or a content object related to the social network, which can include information such as favorite music and movies, favorite books, hobbies, schools attended, a current job, and etc. Then, other users on the social network are able to connect (e.g., create a relationship in a social network) with the user based on the information in the user's profile.

Among various interests that can be used to connect people, media such as music, movies, books, pictures, and etc. can be a common basis for making connections, especially in this era where users are constantly surrounded by media via digital content, Internet, radio, television broadcasting, and other means. Even in an ordinary social setting, people often exchange their interest in music or movies as a part of their conversation in getting to know one another. For example, it is common for two people to decide to go see a live music by an artist after finding out that they both like the same artist. Further, people often try to create social groups so that people with similar preferences in music or movies can gather together and share their interest. These social gatherings may be initiated by interest in media at first, but can also provide useful means to develop wider range of social purposes other than the interest in media. For example, people may join a musical interest group and initially meet people to pursue similar musical interest, and then they can become friends who may socialize in a different context other than musical interest. This is partly because media can define various aspects of a person and thus can be used as a common interest that people can use to connect with one another.

Therefore, in order to fully experience a social networking service, the user often spends considerable amounts of time and effort to enter and update information related to interests and characteristics of the user (e.g., media or content preferences). In many cases, the more information the user provides to the social networking service, the more comprehensive experience the user will have in using the social networking service. However, many users forgo the process of creating a profile on the service because the process is too burdensome or time consuming. Moreover, because the user may not remember some of the information related to the user or may not have it readily available, the user may have to spend time performing research or looking up such information to be entered in the profile of the user. As a result, a significant portion of users have little or no information in their respective profiles which can result in a poor user experience on the social network.

To address this problem, a system 100 of FIG. 1 introduces the capability to automatically complete or fill a profile of a user associated with a service (e.g., a social music service, a social networking service, etc.) using existing information available in one or more devices associated with the user. In this way, the system 100 advantageously reduces the amount of information that a user has to manually enter to participate in a social network or to share interests using a content object. More specifically, the system 100 provides the following capabilities: (1) to determine whether an update is needed based on the user information in a user equipment, (2) to automatically retrieve user information to update a content object of a service (e.g., a social music service), (3) to dynamically present the automatic content information retrieval process, and (4) to select which user information to display on the content object. By way of example, the system 100 allows updating the content object for sharing a user's preference in media or content (e.g., content preferences such as musical taste, etc). In the approach described herein, the system 100 automatically updates or populates a user' media profile with minimal user input. In this way, users can automatically populate their content objects or similar social networking profile with little effort, thereby encouraging users use the available functions of the content object or corresponding service to the fullest extent.

As shown in FIG. 1, the system 100 includes a service platform 101 with connectivity to a web server 103 and user equipment (UEs) 105a-105b over the communication network 107. For the sake of simplicity, FIG. 1 depicts only two UEs (e.g., UEs 105a-105n) in the system 100. However, it is contemplated that the system may support any number of UEs 105 up to the maximum capacity of the communication network 107. In one embodiment, the network capacity may be determined based on available bandwidth, available connection points, and/or the like. The web server 103 further includes one or more web pages 109 including one or more content objects 111 to facilitate automatic and efficient sharing of content.

The content for the content object, for example, is provided by one or more of the services 113a-113n of the service platform 101. In one embodiment, the service platform 101 includes one or more services 113a-113n (e.g., social network service, media service, mapping service, video service, etc.), a media manager 114, a user account manager 115, a media database 116 and a user account database 117. In one embodiment, the services 113a-113n are services provided by a service provider or an operator of the network 107. The user account manager 115, for instance, manages user account information including, e.g., user login credentials, for accessing the services 113a-113n. In one embodiment, user account manager 115 enables use of a set of login credentials to access multiple services 113a-113n. In other embodiments, the services 113a-113n may use separate login credentials. By way of example, the user account manager 115 may be used to store login credentials and user account information in the user account database 117. In addition or alternatively, the user account database 117 can reside on one or more nodes connected directly or indirectly to one or more of the services 113a-113n. In other embodiments, user account database 117 resides on one or more nodes in network 107. More specifically, the user account database 117 includes one or more processes (not shown) and one or more data structures that stores information about registered user of each of the services 113a-113n including login credentials and related information as well as data, configurations, user profiles, media profiles, variables, conditions, and the like associated with using any of the services 113a-113n. Further, by way of example, the media manager 114 may be used to store media files or files related to media in the media database 116. In addition or alternatively, the media database 117 can reside on one or more nodes connected directly or indirectly to one or more of the services 113a-113n. In other embodiments, the media database 117 resides on one or more nodes in network 107. More specifically, the media database 117 includes one or more processes (not shown) and one or more data structures that stores information about the media related to a user of each of the services 113a-113n including media files and information related to the media, variables, conditions, and the like associated with using any of the services 113a-113n.

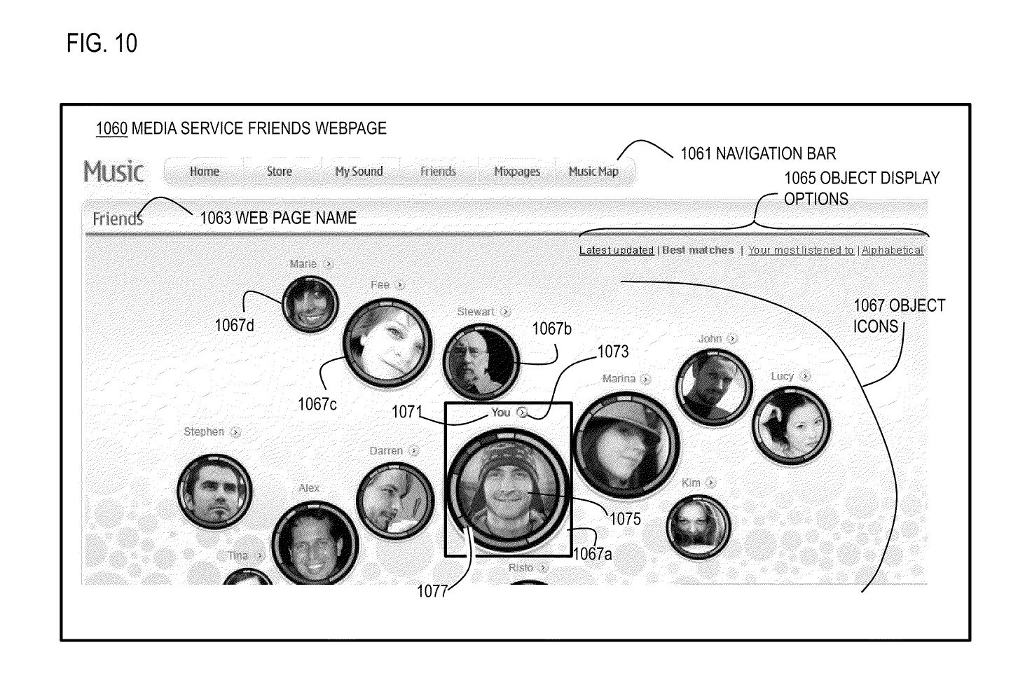

One or more of the services 113a-113n (e.g., the service 113a) can include a content object service 119 to enable content-sharing software objects, or content indicator software objects, called content objects 111 herein, to be delivered to a user's terminal for embedding into other web sites, as described in more detail below with reference to FIG. 10. Software objects that are self-contained collections of data and methods are widely known and used in object-oriented programming (OOP). Thus, as used herein, a content object 111 is a software object that can be embedded in a web page or email or other message for presentation to a user. As described previously, the content object 111 enables interaction with the nature and availability of content and/or services provided by the object 111. The content object 111 also enables the owner of the content object 111 to present content preferences including the owner's taste as expressed in a content playlist accessible by other users. In one embodiment, the content object service 119 includes an application programming interface (API) (not shown) to communicate and/or control the execution, embedding, or sharing of the content object 111 in the web page 109. By way of example, the API defines routines, data structures, procedures, protocols, and the like that the content object 111 can use to exchange information with the corresponding service 113. For example, the API may include an application to upload and/or share photos or videos, or an application to allow embedding of on-line media on a website.

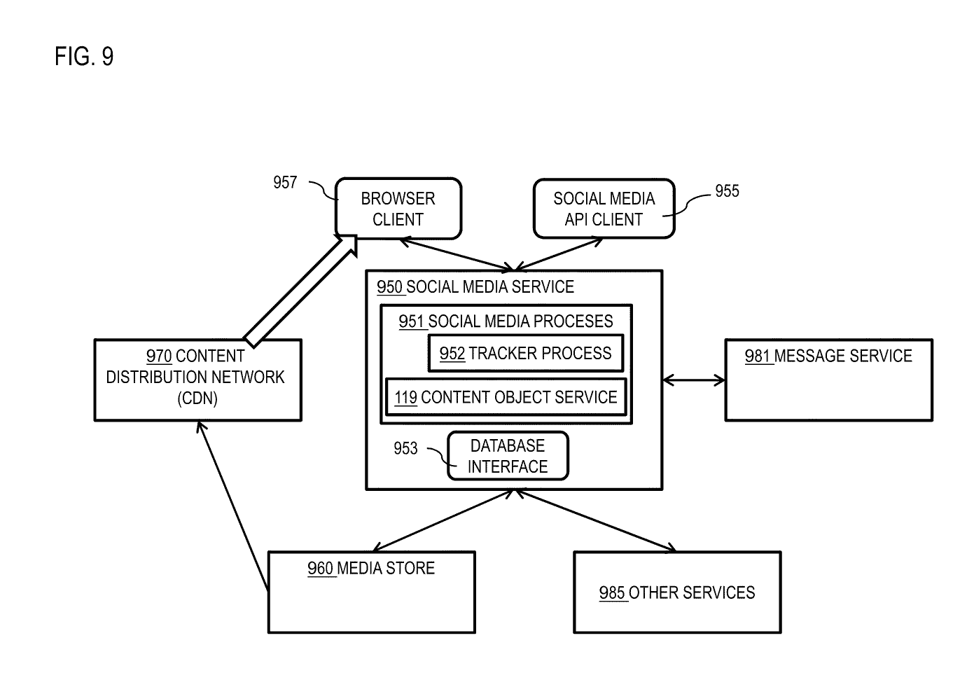

In some embodiments, the web server 103 interacts with the content object service 119 to embed one or more content objects in one or more web pages (e.g., web page 109) delivered to a user's web browser (e.g., browser 121a on UE 105a or browser 121b on UE 105b), as described in more detail below with reference to FIG. 9. In addition or alternatively, the one or more web pages 109 may be delivered to the 10 of UE 105a or service application 123b of UE 105b. In one embodiment, the service applications 123 are local clients of the corresponding service 113 of the service platform 101. Thus web server 103 is depicted as including the web page 109 that includes the content object 111. In other embodiments, content objects 111 are embedded in messages sent by other application servers or clients, e.g., messages sent from email, instant messaging (IM), and file transfer servers.

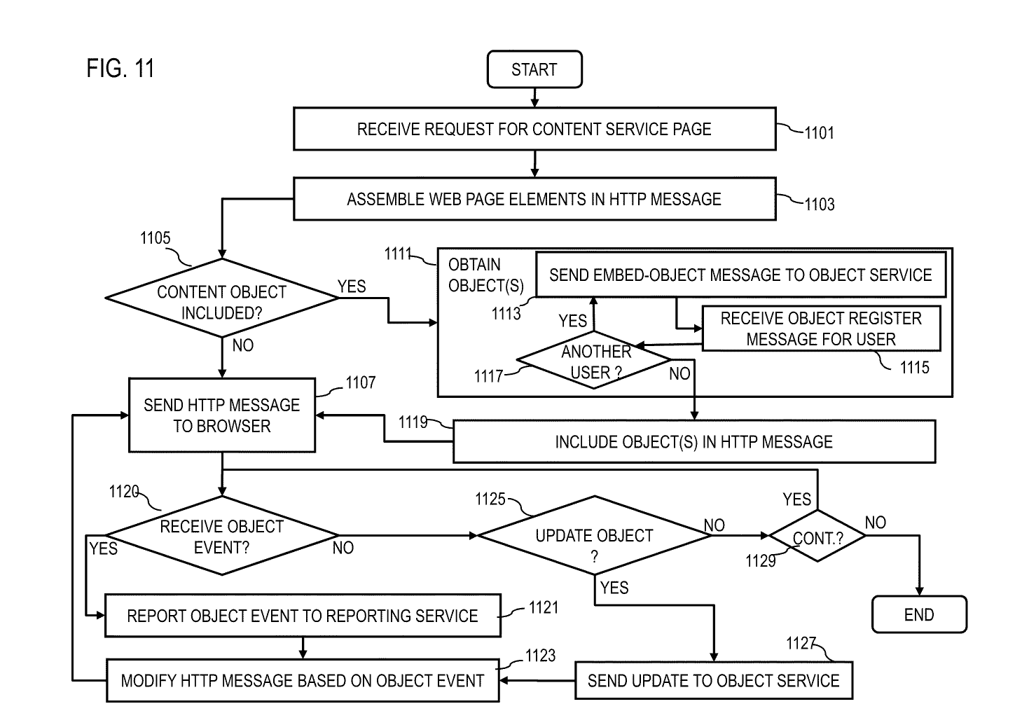

In one embodiment, the service platform 101 and the web server 103 can be implemented via shared, partially shared, or different computer hardware (e.g., the hardware described with respect to FIG. 11).

By way of example, the communication network 107 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

The UE 105 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, game device, positioning device, electronic book device, television receiver, radio broadcast receiver, or any combination thereof. It is also contemplated that the UE 105 can support any type of interface to the user (such as “wearable” circuitry, etc.). The UE 105 may also be equipped with one or more sensors (e.g., a global positioning satellite (GPS) sensor, accelerometer, light sensor, etc.) for use with the services 113a-113n.

By way of example, the UEs 105, the web server 103 and the service platform 101 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

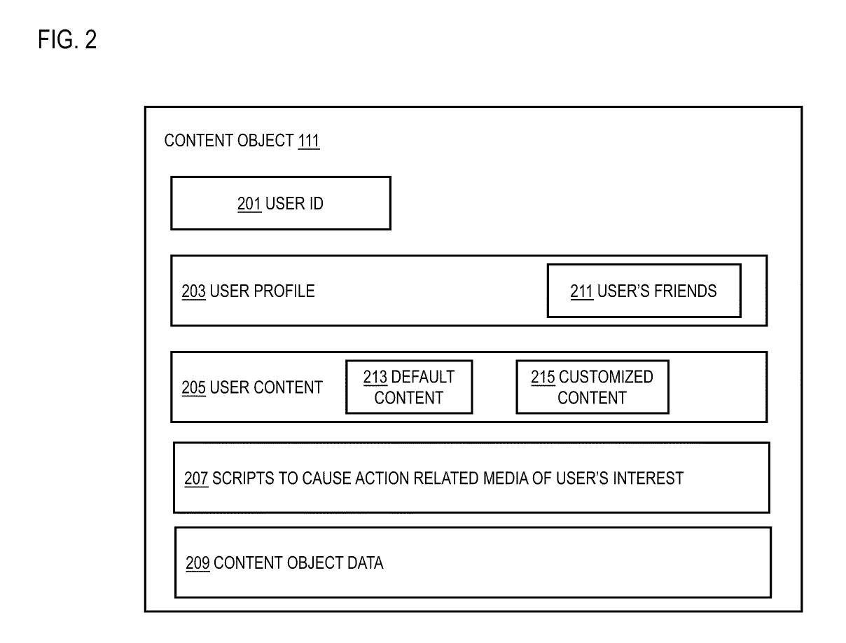

FIG. 2 a diagram of a content object, according to one embodiment. By way of example, the content object 111 includes one or more components for presenting content from a service 113 and customizing the interaction behavior of the content object 111 based on, for instance, the availability of content presented by the content object 111. As discussed previously, the content object can also be used to represent the content preferences (e.g., musical tastes) of a particular. It is contemplated that the functions of these components may be combined in one or more components or performed by other components of equivalent functionality. In one embodiment, the content object 111 includes, for example: (1) a user ID field 201; (2) a user profile field 203; (3) a user content field 205; (4) script field 207 holding or pointing to scripts to be executed by a client process in order to cause actions related to interacting with the content object 111; or a combination thereof.

The user ID field 201 holds data that indicates, for example, a user registered with the service 113 associated with the content object 111. Any user ID may be used, such as a node identifier for the device used for rendering the content, a user supplied name, an email address, or an ID assigned to a user who registers with the service platform 101. In some embodiments, a user ID is inferred from a node identifier for the device used for rendering the content included in a lower protocol header. In some embodiments, the user ID field 201 is omitted. In some embodiments, a user is authenticated and authorized to access the service platform 101 in a separate login process, not shown, but well known in the art.

The user profile field 203 comprises data that indicates the user profile of the owner of the content object 111 (called owner hereinafter), such as one or more of any of the following: an index for the owner into the user account database 117; the owner's authorization or login credentials (such as password for accessing the user's home page); a pointer to the content in the service 113; one or more home pages for the owner on corresponding social networks, contact lists; and/or other external services 113; the user's contact information such as email address, an image of the owner, a theme song of the user, a visual theme of the owner, or an avatar of the owner. The example user profile field 203 includes the owner's friends field 211 that holds data that indicates one or more user IDs of other users associated with the owner in the one or more social networks and/or contact lists. In the approach described herein, all or a portion of the user profile field 203 may be automatically filled or entered by the content object service 119 or service application 123 from existing information available on the UE 105 or other device or application 123 associated with the user.

The user content field 205 holds data that indicates the content identifiers (content IDs) for one or more content items (e.g., music track, video, etc.) associated with the owner in the corresponding service 113 (e.g., music play history, such as values for song name and artist name in a music service). In the illustrated embodiment, the user content field 205 includes a default content field 213 and a customized content field 215. The default content field 213 holds data that indicates the predetermined content to display with respect to the service 113 of the content object 111. For example, in a music service, the default content field 213 can specify the playlist that represents the owner's theme or preferences in content, such as a theme song for the owner and/or the owner's top ten songs. The customized content field 215 holds data that is customized based on identification information associated with the viewer. In addition or alternatively, the customized content field 215 indicates the content information representing the most recently rendered or currently rendered content of the owner (e.g., the song currently playing on owner's UE 105) or status of a data transfer (e.g., the status of a file being uploaded to the service 113a) or other real-time status information of the owner (e.g., active or inactive state, service accomplishments, etc.). In the approach described herein, the availability of content in the user content field 209 dictates the interaction behavior (e.g., available functions, alerts, messages, etc.) provided by the content object 111. Additionally, as described with respect to the user profile field 203, the default content field 213 and customized content field 215 may be automatically filled or entered using information available from the UE 105 or other user device.

The script field 207 holds data for one or more scripts that indicates one or more processes and/or actions to be performed by the content object 111, such as a process to present the content object 111 to a user and a process to respond to user input associated with the content object 111, such as activating an action presented by the content object 111 (e.g., playing the owner's theme song, playing the owner's current song, playing short segments (denoted as “snippets”) of all the content in the playlist, playing the owner's top ten list, buying currently/previously playing content, requesting more information about some content, and/or sending messages or otherwise contacting the owner of the locket). In one embodiment, the script field 207 also holds data for one or more scripts to initiate processes for determining the availability of content provided the content object 111, determining the interaction behavior of the content object 111 based on the availability of the content, determining the capabilities (e.g., input/output capabilities) of a device requesting access to an embedded content object, and mapping controls of the content object 111 based on the determined capabilities. In yet another embodiment, the script field 207 can hold data for one or more scripts to initiate the process for automatically updating or entering profile and content information of the content object 111. As is well known in the art, scripts are instructions that cause a web browser or other like application to perform one or more functions. For example, script in the JAVA™ programming language, called a JAVA applet, causes a web browser with a Java engine to perform the steps indicated in the script, as is well known in the art. In other embodiments, the script field 207 may include information or data to support implementation other methods including scripting or script-like functions such as Adobe Flash (ActionScript), AJAX, Web Runtime (WRT), and the like.

The content object data field 209 holds other data used by the content object 111, such as an image (icon) and/or avatar to represent the content object 111 on a display device, type or form of the content object 111 (e.g., a circle, bubble, star form, rectangle, cube, polyhedron) and/or other related information (e.g., degree of similarity between the viewer and the owner; the percentage of the locket owner's playlist or play history, or both, that falls into each of multiple categories; etc.).

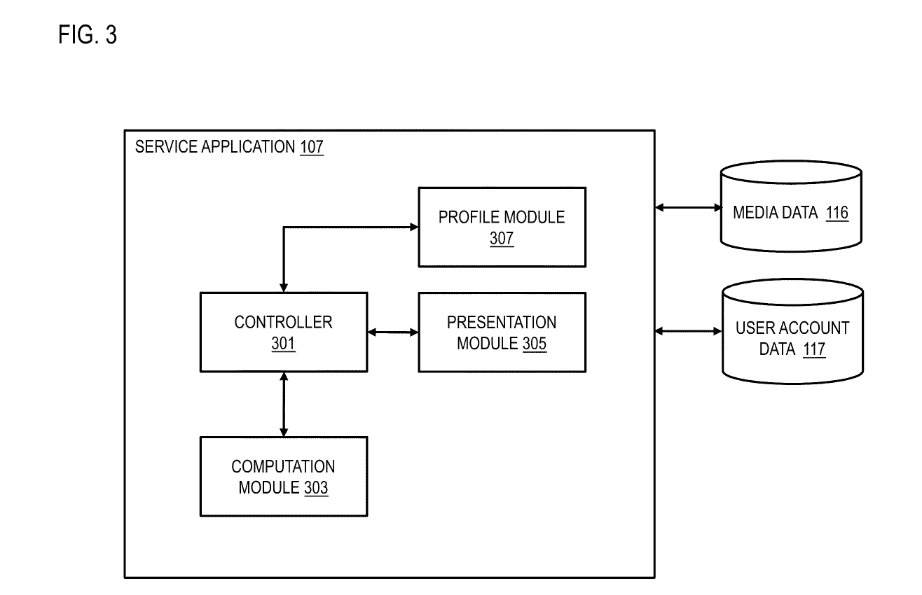

FIG. 3 is a diagram of the components of the service application 107, according to one embodiment. By way of example, the service application 107 includes one or more components for updating a media profile of a content object 111. It is contemplated that the functions of these components may be combined in one or more components or performed by other components of equivalent functionality. For example, the content object service 119 and the service 113a may, in addition or alternatively, include the components described below and/or perform the functions of the service application 107. In this embodiment, the service application 107 includes a computation module 303, a presentation module 305 and a profile module 307. The controller 301 oversees tasks, including tasks performed by the computation module 303, the presentation module 305 and the profile module 307. The computation module 303 performs various computations and estimations based on given information, including computations for collecting information regarding the 205 playback history of media and forming a playlist according to preset conditions. The presentation module 305 manages information and allows controlling of a presentation of the information in the service application 107, such that the information can be displayed using the service application 107. The presentation module 305 may also provide controls for a presentation of the webpage 109 and/or the content object 111. The profile module 307 manages information about a user, and may organize them in different categories. The information about the user may include basic information such as the user's name, gender, date of birth and etc., but also may include user's hobbies, favorite music, movies and books. The profile module 307 may communicate with the computation module 303 through the controller 301 to retrieve any information about the user that the computation module 303 computes, such as the most played media file by the user. The service application 107 may also connect to a database such as the media database 116 and user account database 117, such that information from the user equipment 105a can be sent to the databases and that various other devices can access information stored in databases. The data stored in the user account database 117 may include user credential data such as a user id and a password corresponding to the user id.

The service application 107 may be configured so that, if the user has never used the service 113a before, the service application 107 automatically sets up an account for the user for the service 113a when the user launches the service application 107. Alternatively, the relationship between the service application 107 and the service 113a may be configured such that the only way to set up a user account for the service 113a may be done by launching the service application 107 for the first time. The service application 107 may also be configured so that the user identification (ID) and password for the service is automatically provided upon launching of the service application 107, and thus a user does not have to manually enter the user ID and password to access the service. Then, the service application 107 can automatically connect to the service 113 and begin communicating as soon as the service application 107 is launched, without having to wait for the user to enter the user credential information.

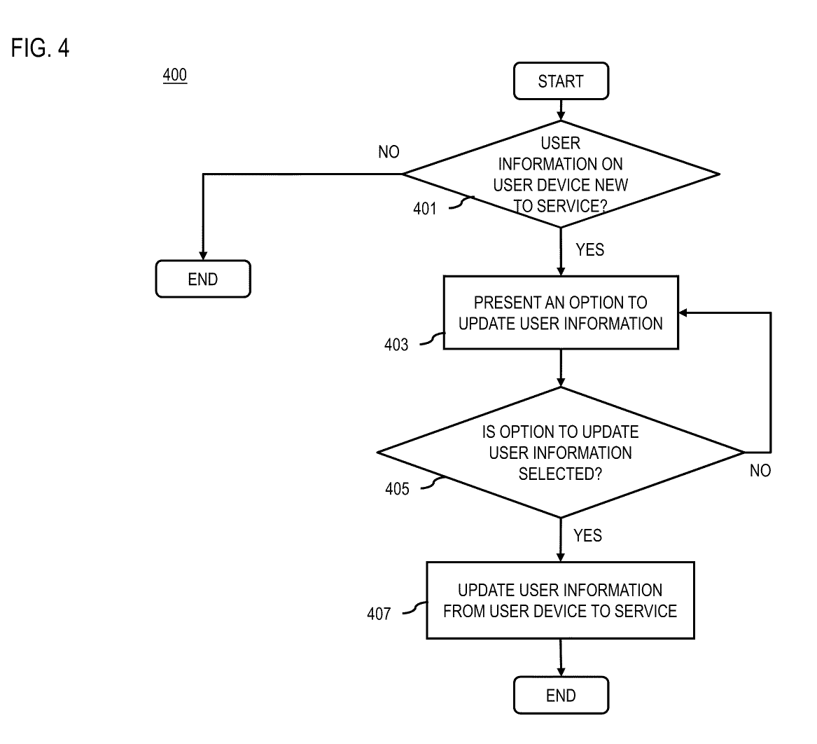

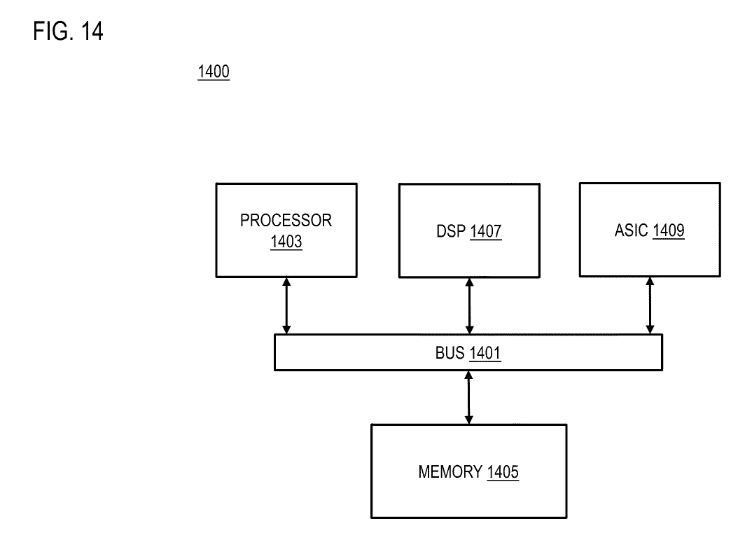

FIG. 4 is a flowchart of a process for determining whether to update a media profile, according to one embodiment. In one embodiment, the service application 107 performs the process 400 and is implemented in, for instance, a chip set including a processor and a memory as shown FIG. 14. In step 401, the service application 107 communicates with the service 113a to determine whether new user information (i.e. the user information that the service does not have) exists on the user equipment 105a. The user information may be new to the service 113a if the user has not used the service 113a before (e.g. a first time user of the service 113a) or has not entered any information in the service 113a. Alternatively, the user information on the user equipment 105a may be new to the service 113a if the user has changed the user information on the user equipment 105a. If step 401 decides that there is no new user information in the user equipment 105a, then the process for updating a media profile ends. If new user information exists in the user equipment 105a, the service application 123 presents an option to update the service 113a with the new user information, as shown in step 403. The option may be presented as a graphical interface such as a graphical button to choose to initiate the update. If this option is selected, the user information is updated from the user equipment 105a to the service 113a.

For example, this process may be useful for a user using the service 113 for the first time. As an example of a first time user of the service 113, a user may install a media widget as the service application 107 for the first time, which automatically connects to the media service as the service 113a. Then, the service application 107 determines that there is no user information on the profile of the user in the media service because the user is new to the media service. Thus, the service application 107 prompts an option to update information in the profile of the user in the media service, and upon selection of the option to update, the service application 107 update the user information from the user equipment 105a to the media service. As another example, instead of presenting an option to update user information, the updating of new user information from the user equipment 105a to the service 113a may be performed automatically when it is determined that new user information exists in the user equipment 105a. Further, in another embodiment, the process 300 may be performed by the service 113a

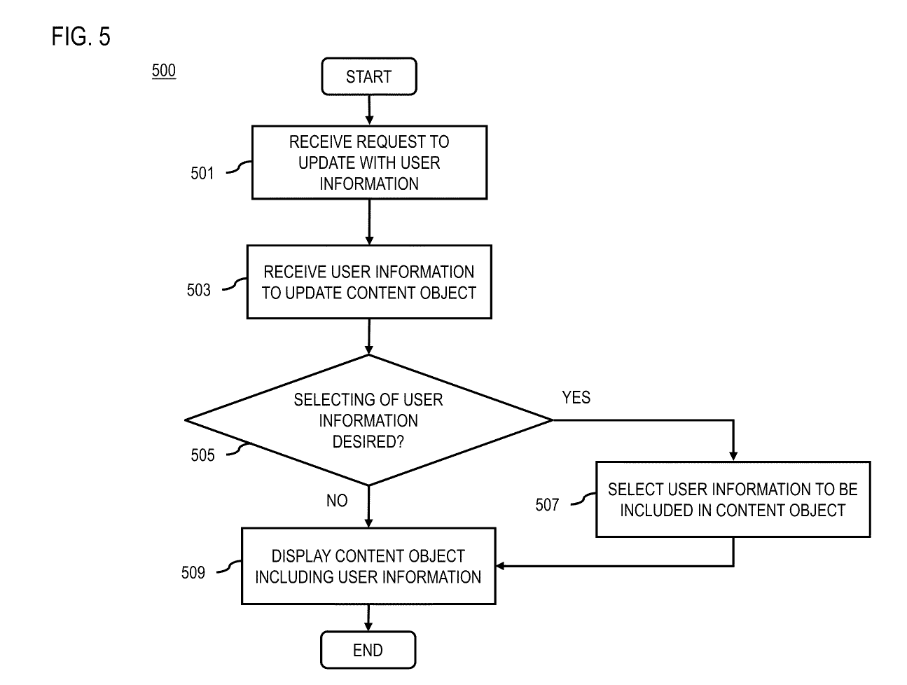

FIG. 5 is a flowchart of a process for updating a media profile, according to one embodiment. In one embodiment, the service application 107 performs the process 500 and is implemented in, for instance, a chip set including a processor and a memory as shown FIG. 14. In step 501, once it is determined that an update with the information from the user equipment 105a is desired, a request to update is received by the service application 107. Then, in step 503, the information about the user (e.g. user information) from the user equipment 105a is received to provide an update for the content object 111. For the purpose of the media profile, the user information may include user's preference information about media that the user prefers, such as a list of most frequently listened songs and songs that are in the playlist in the user equipment. The user information may also include any information about the user, including the user's profile picture, the user's name, the user's birthday, hobbies, favorite music, movies and books and etc. Further, if the user equipment 105a has a camera, then a picture may be taken and be uploaded as the profile picture, which may be stored in the user account database 117. It may be desirable for a user to select user information to be displayed on the content object 111, due to various reasons. For example, the content object may not have sufficient space to display all the information in the user information, and thus the user may want to select only certain information to be displayed. Further, the user may not want to display some of the information in the user information, such as information that the user does not want to make public. Therefore, an option of selecting user information to be displayed may be provided, as illustrated in step 505. If it is desired to select user information, certain information may be selected, as shown in step 507, and then the selected information is displayed, as shown in step 509. If it is not desired to select user information, then all of the information available is displayed on the content object 111, as shown in step 507.

Step 505 may be a manual process where a user manually selects information to be displayed, or may be an automatic process where certain information is selected if certain conditions are satisfied. For example, if the content object 111 does not have a sufficient space to display all of the information, then a notice may be prompted such that a user may manually select the information to be displayed. As another example, if the content object 111 does not have a sufficient space to display all of the information, then some of the information may be automatically selected, randomly or based on certain conditions set by a user. The user may set a condition such that a different weight is given to each information based parameters such as release date of the media, the most recent time the media was played, frequency of use, ratings, and etc. Then, information with the highest priority weights (e.g. information with top three priority weights) may be selected to be displayed on the content object 111. The information may be ranked based on conditions, and only a predetermined number of top (or bottom) information on the ranking list may be selected to be displayed on the content object 111.

Many different types of information may be considered to show the user's preferences in media. For example, a record showing a user's history of accessing files related to media may be stored and used later to show the user's preferences or tendencies in accessing the files. Based on this record of user's history, a list of most frequently played media may be compiled. This list may be categorized by various parameters such as the type of media, date, genre and etc. Further, this list may be customized by setting parameters, such as genre, artist, time of release and etc. For example, if genre is used as a parameter, the setting can be configured such that only top three most frequently played rock songs, top five most played jazz songs and top ten most played rap songs are listed. In addition, this information on user's history may be scaled based on various factors, such as time of the access and frequency of the access under external circumstances such as advertisements of the media. If different types of lists of media based on different standards are available, then an option may be available to allow the user to select list(s) to use to update the content object 111.

In one embodiment, if the UE 105 includes a camera module (not shown), the service application 107 may direct the camera module to capture an image to the user to include in the content object 111. For example, the image is displayed in content object 111 to identify the user to other viewers of the content object 111. If the UE 105, the service application 107 may search the UE 105 for stored images. If any images are found, the service application 107 may present them to the user for selection as the representative picture for the content object 111.

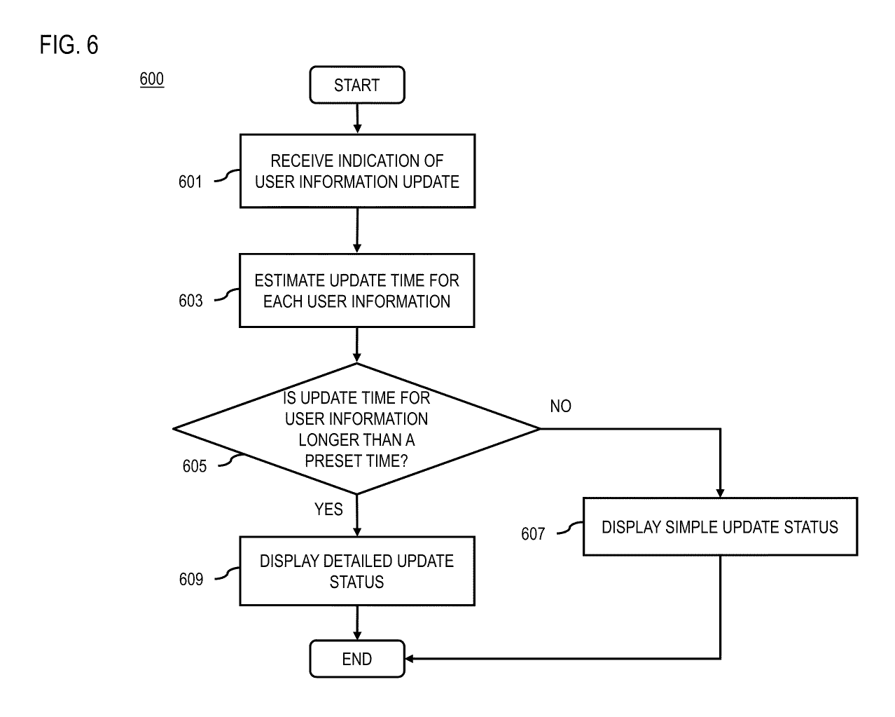

FIG. 6 is a flowchart of a process for displaying a progress of an updating a media profile, according to one embodiment. In one embodiment, the service application 107 performs the process 600 and is implemented in, for instance, a chip set including a processor and a memory as shown FIG. 14. During an update, it is desirable to display the progress of update of information in order to provide the user with information on the progress and the information being uploaded. In step 610, an indication that user information is updated is received. Then, the update time is estimated for each part of information (e.g. each file), as shown in step 603, to determine whether the estimated update time for one part of the information being updated is longer than a preset time (e.g. 2 seconds), as shown in step 605. If the estimated update time for the part of the information is longer than a preset time, then a detailed update status is displayed, as shown in step 609. For example, if the estimated update time for a media file is longer than a preset time of service application 107 seconds, it may be beneficial to display detailed information about the media file because a user will have time to look at the displayed detailed information during the estimated time of longer than 2 seconds. On the contrary, if the estimated update time for the part of the information is not longer than a preset time, then a simple update status is displayed, as shown in step 607. This is because it may take a long time to load detailed update status, and thus if the estimated update time is relatively short, the detailed update status may not load completely during the short update time. Further, detailed update status will not be necessary for the user because the user would not have time to look at the details on the detailed update status if the update status changes very quickly due to the short update time.

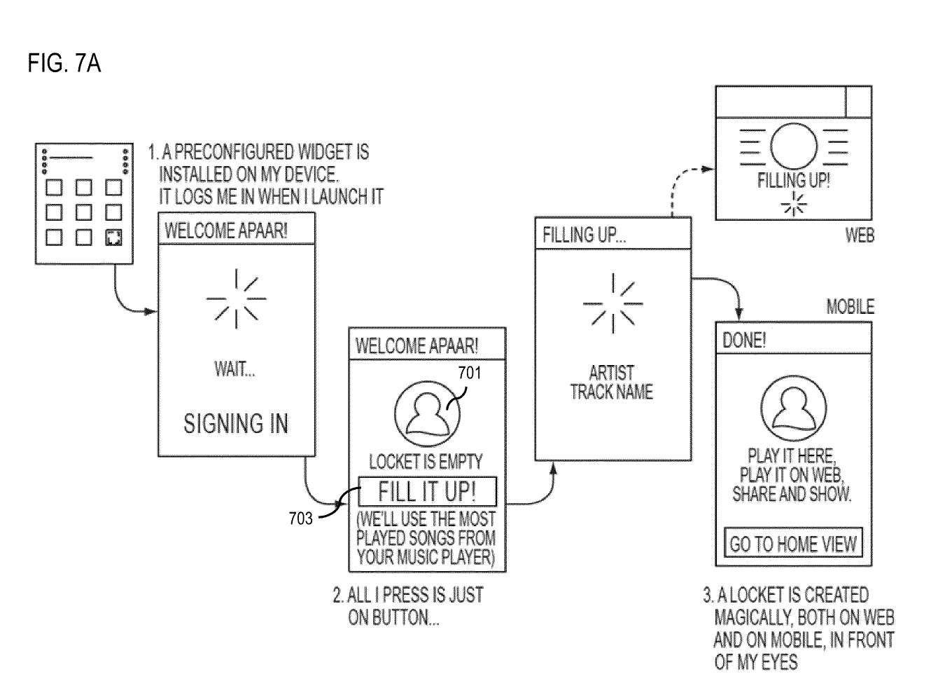

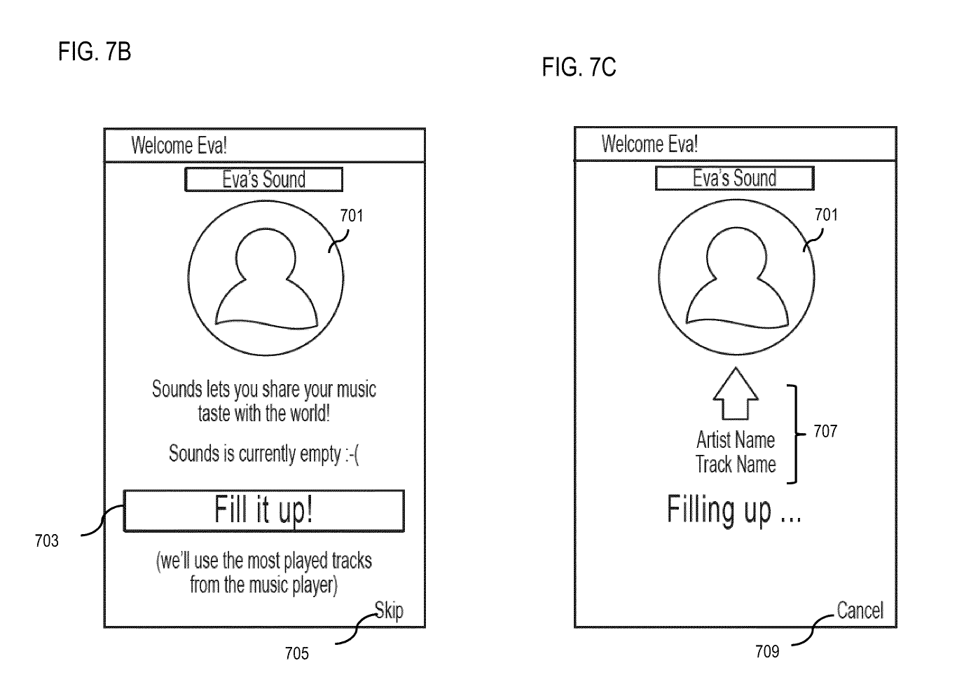

FIGS. 7A-7C are diagrams of a user interface for user equipments 105a-105n utilized in the processes of FIG. 4, according to various embodiments. FIG. 7A shows an overall process for updating a media profile, according to one embodiment. First, after a service application (e.g. widget) is installed for the first time in the user's device, the widget logs in the user and communicates with the service, upon launching of the widget (see step 1). Then, when it is determined that the information on the user's device is new to the service, the widget displays an option to update (i.e. fill up) the service with the information on the user's device (see step 2). Upon selection of the option to fill up, the user's device and/or the webpage displaying the content objects with information from the service show the progress of the update. After the information is updated, the widget and/or the webpage show that the update is completed (see step 3). FIGS. 7B and 7C show an example of a user interface of the widget on the user's device. As shown in FIG. 7B, the widget may show a profile picture 701 corresponding to the user, display an option to update the information from the user device to the service 703 (e.g. an option “Fill it Up”) or an option to skip the update 705 (e.g. “Skip”). When the option to update is selected, the user device may show the progress of the update 707 by displaying a status message (e.g. Filling up) and detailed information about the information being updated (e.g. artist name, track name and etc.). An option to cancel 709 may be provided to cancel the update while the update is in progress.

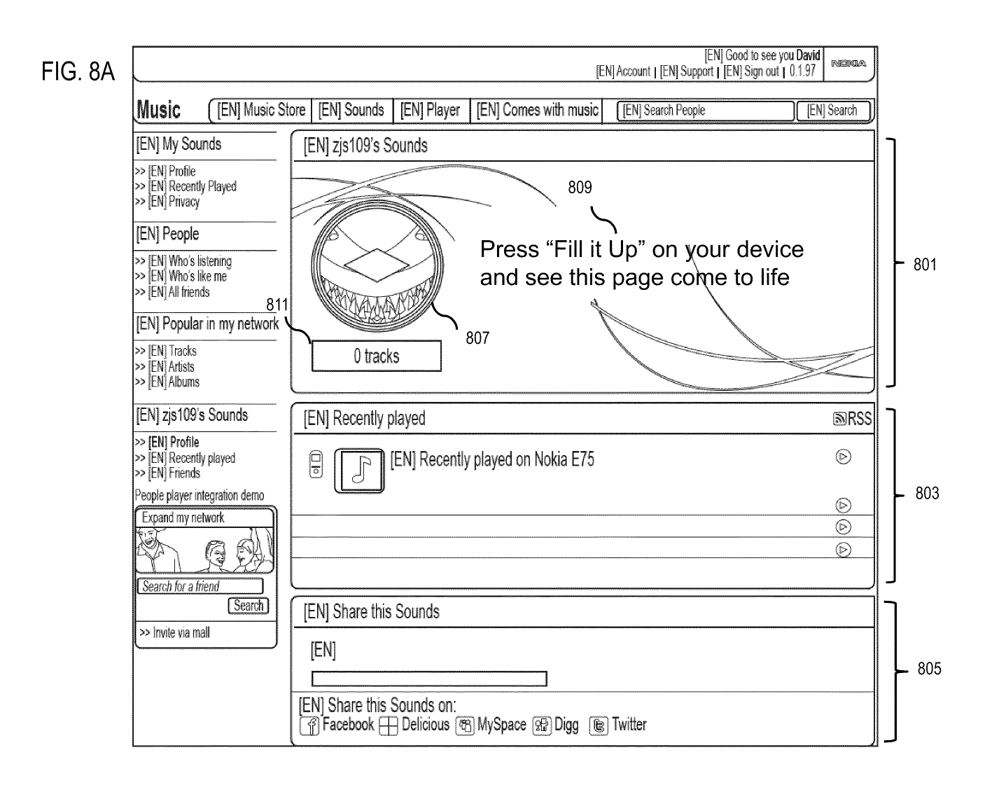

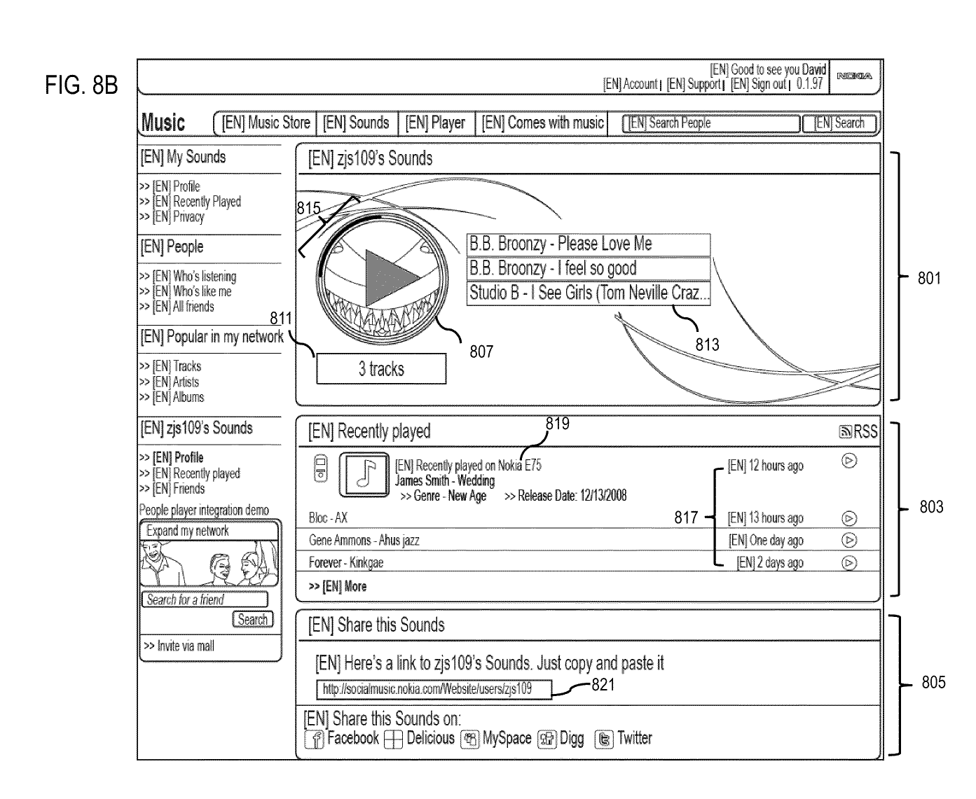

FIGS. 8A-8B are diagrams of a user interface for a webpage 109 with content objects 111 displaying information from the service 113a, utilized in the processes of FIG. 4, according to various embodiments. FIG. 8A shows the webpage displaying the content objects with the information from the service. In the example shown in FIG. 8A, there are at least three content objects, which are “zjs109's Sounds” 801 (i.e. user's sound files, wherein zjs109 is the user id), “Recently Played” 803 (i.e. recently played sounds) and “Share this Sounds” 705 (i.e. web address to the sound). When the user device has information that is new to the profile, the user can press “Fill it Up” option 703 on the user's device and update the information. FIG. 8A also shows that the user's profile picture 807 is automatically uploaded from the user equipment and shows the user's profile picture 807 on this webpage as a content object. Further, the webpage illustrated in FIG. 8A displays the message 809, “Press ‘Fill it Up’ on your device and see this page come to life, in order to inform the user.” Before the update begins, a tracking widget 811 shows that 0 tracks are uploaded. If the user selects the “Fill it Up” option 703, then the update begins and the progress of the update is shown on the webpage, as shown in FIG. 8B. Under the content object zjs109 Sounds, the progress of the update 813 can be shown by listing information about the medial files that have been updated or is being updated, and a progress bar 815 can be shown as a graphical representation of the update progress. As files are being updated, “Recently Played” section has a list of the medial files in an ascending order of the most recent access of the medial file (see 817). Further, under the “Recently Played” section, a media file or a sample of a media file may be selected to display more details 819 about the media file such as the genre and the release date and/or to play the media file through the webpage. The “Share this Sounds” section shows a web address 821 to the selected media file, such that a user may have a direct link to the media file. An option may also be shown to share the media file using various social networking services such as Facebook or MySpace.

FIG. 9 is a diagram of components of a service, according to one embodiment. In the illustrated embodiment, the service 113 is a social media service 950 and supports users in finding and playing media on their local devices (e.g., UEs 105) over the communication network 107. The social media service 950 includes social media processes 951 and a database interface process 953. The social media processes 951 are a set of applications (e.g., a Java™ stack written in the Java™ programming language that can be installed and executed on any device that includes a Java™ virtual machine (JVM) process). The social media processes 951 include instructions for finding songs played by various users and metadata about songs and using the metadata to direct users to resources on the network where the user can sample, purchase or download those songs, alone or in some combination. The database interface process 953 is the interface between the social media service 950 and the content databases (not shown) available over the communication network 107; and is used to retrieve and store user information, metadata, and event data, and to retrieve and store content.

In the illustrated embodiment, the social media processes 951 include played content tracker process 952 to track played content and to use the database interface process 953 to store and retrieve the event data that describes what is being played by whom and when. In the illustrated embodiment, the social media processes 951 include a content object service 119.

According to the approach discussed herein, a content object 111 can be created to illustrate the preferences of a content services user based on that person's content rendering list (i.e., playlist) or content rendering history (i.e., play history). For example, a content object 111 is created to illustrate the a social media service client user's preferences in media, such as music, movies and books, based on that person's play list or play history. After the content object 111 is generated in the content object service 119 of the social media service 950, the content object 111 can be emailed to other users in the particular user's social network or posted to a social network web page, such as a Facebook web page, or transferred via an instant messaging (IM) service or a web blog.

For example, a user operates a media content object 111 by interacting with the content object service 119 (directly or indirectly through a web page) in at least two ways. First, the user imports his or her play history (e.g., from last.fm, from yahoo music, iTunes, or from some other media service). For example, in some embodiments, the user's media profile is automatically collected from the media that the user plays with that person's mobile phone (e.g., UE 105). Secondly, the user chooses media, such as a song, a video clip and a book, as a theme media that best represents the user's preferences in media, and populates the content object with multiple other media selected from the user's play history. In many embodiments, the user also uploads to the content object 111 an image to represent the user's preferences in media, such as an image of the user or an image associated with the theme media.

For example, the content object service 119 implements a media content object 111 that will play a musical profile of the particular user as, for instance, clips of music on the particular user's playlist. The media content object 111 can be embedded in various social web pages or embedded in other messages. Any user in the social network may activate the content object 111 from the social network page (presented to a user via browser 121) or other message presentation client. The clips of content in the content object 111 can be played via the UE 105. In an example embodiment, the media content object 111 has direct access to a media store 960 to enable the listener to purchase the song for the clip being played. Thus a user can show off the user's favorite tunes to friends in a social network or other network application. Furthermore, a user can discover and/or purchase one or more favorite songs of a friend in the user's social network or other network application.

In one embodiment, the social media service 950 interacts with other processes on the network 107 using the hypertext transfer protocol (HTTP), often in concert with the Representational State Transfer (REST) constraints. The other processes may be on the same node or on different nodes.

In some embodiments, a user's device (e.g., UE 105) includes a service application 123 to interact with the social media service 950, and a browser 121 to interact with web pages using HTTP. In some embodiments, interactions with the user can be through web pages and the user's browser 121; so that a separate service application 123 is omitted. The social media service 950 interacts with one or more media store systems 960, such as the NOKIA™ Music Store, to purchase songs to be downloaded to a user's device. The download is often accomplished using a Content Distribution Network (CDN) 970. The media store 960 authorizes the CDN 970 to download to the client and then directs a link on the user's browser 121 to request the content from the CDN 970. The content is delivered to the user through the user's browser 121 as data formatted, for example, according to HTTP or the real-time messaging protocol (RTMP) or the real-time streaming protocol (RTSP), all well known in the art. As a result, the content is stored as local content the user's device (e.g., UE 105). The local content arrives on the UE 105 either directly from the CDN 270, or indirectly through some other device or service (not shown).

In some embodiments, the social media service 950 uses a message service 981 to receive event data about playback events on the user's device. In some embodiments, the social media service 950 uses other services 985 (e.g., services 113a-113n) available on the network 107 such as people services to connect with other persons in a social media group of persons, mapping services to show a user's location and points of interest on a map, and gaming services to determine the user's status in one or more games.

FIG. 10 is a diagram of an example web page with multiple content objects embedded thereon, according to an embodiment. The webpage 1060 is presented to a particular user of multiple registered users of a service 113 (e.g., a media service), and includes a navigation bar 1061, a web page name 1063, content object display options 1065, and one or more content object icons 1067.

The navigation bar 1061 includes active elements that can be selected by user input (e.g., via operation of a pointing device) to move among multiple web pages to be presented to the user, as is well known in the art. The web page name 1063 indicates the name for the web page currently presented to the particular user. It is assumed for purposes of illustration that the content objects of the particular user of the web page and the friends of the particular user of the webpage are presented on the web page named “Friends,” as shown.

The locket display options 1065 includes active elements that can be selected by user input (e.g., via operation of a pointing device) to chose among multiple different ways to present the content objects on the Friends web page. In the illustrated embodiment, the particular user can select among presentations that indicate: the friends' content objects most recently updated; the friends' content objects that most closely match the particular user's own playlist; the friends' content objects whose owners listen to them most; and alphabetical ordering of the friends' content objects.

As shown in FIG. 8, the content object icons 1067 are arranged to indicate the friends' content objects that most closely match the particular user's own playlist. The particular user's own content object icon 1067a is depicted along with the content object icons (e.g., content object icons 1067b, 1067c, 1067d) of friends of the particular user. Each content object icon 1067, such as content object icon 1067a, presents: a name 1071 of the content object owner; an active element 1073 to play content associated with the locket in response to input from the particular user; an image 1075; and a ring 1077 of content categories surrounding the image 1075. In the illustrated embodiment, the ring is color coded, with each color representing a different category of the content. For example, in social media content objects 111, the ring categories use different colors to represent each of classical, big band, folk, rhythm and blues, rock and roll, country, heavy metal, grunge, hip-hop, etc. By way of example, the percent of the ring colored for a particular category matches the percentage of the locket owner's playlist (or play history) that falls in the particular category.

In the illustrated embodiment, the degree of matching or similarity is indicated by the proximity of a friend's content object icon to the particular user's locket icon, with the best matches closest. The direction of the friend's content object indicates the category in which the best match occurs by the category on the particular user's ring intersected by a line segment that connects the two content object icons. The size of the content object icon indicates the size of the friend's playlist. Thus content object icon 1067b indicates a friend's playlist closest to the particular user for a category at 11 o'clock on the particular user's ring. The next match in such a category is a larger playlist indicated by content object icon 1067c, followed by a small playlist indicated by content object icon 1067d.

FIG. 11 is a flowchart of a process in a web server to use content objects 111, according to one embodiment. In step 1101, a request is received for a content service page. For example an HTTP get message is sent from a particular user's web browser with the particular user's authentication credentials, as a result of user input on a prior login page, to the web server 103 for the service platform 101. User authentication and authorization can be performed using well known techniques. In step 1103, a web page for the particular user is assembled, either dynamically or statically, based, for example, on the user credentials.

In step 1105, it is determined whether one or more content objects 111 are to be included in the web page. For example, it is determined whether the user is known, and if known, whether the user has registered with the service 113 of the content object 111. If not, then, during step 1107, the web page assembled in step 1103 is sent in one or more HTTP messages to the particular user's browser 121.

However, if it is determined in step 1105 that a content object 111 is to be included in the returned web page, the one or more content objects 111 are embedded in the web page during step 1111 and step 1119. In the illustrated embodiment, step 1111 to obtain content objects 111 includes steps 1113, 1115 and 1117.

In step 1113, an embed-content-object message is sent to the content object service 119. Any protocol may be used to send the embedded content object message. In an example embodiment, the embed-content-object message includes a type field that indicates the message type is an embed-content-object type and a user ID field. For example, the message is an HTTP Get message, well known in the art, with data indicating the embed-content-object type and a value for the user ID. In some embodiments, the content object service 119 has an application program interface (API) (not shown) and the embedded content object message from the web server 103 is a content object API client call to the content object service 119.

In response to the embed-content-object message, during step 1115, the web server 103 receives from the content object service 119 a content object 111 for the particular user. In step 1117, it is determined whether the content object 111 for another user is also to be embedded. For example, in an illustrated embodiment, the web server 103 also embeds the content objects of the friends of the particular user. The first locket received for the particular user indicates in field 211 the one or more user IDs of the friends of the particular user and/or the one or more social networks where the particular user is a member. This information is used by the web server 103 to send embed-content-object messages to the content object service 119 for each of the friends listed in field 211. When content objects 111 are received for all friends of the particular user, then the content objects 111 are included in the HTTP messages that build the web page in step 1119 and are sent in step 1107 to the particular user's browser 121. During step 919, the content objects 111 are arranged on the web page in any manner, such as in the best matches order depicted in FIG. 8. The script in each content object controls the display of the individual content object icon on the particular user's web browser 121 when the one or more HTTP messages are received at the particular user's web browser 121. For example, the script generates a GUI that causes actions to be performed when the user interacts with the content object 111 in the user's browser 121.

When the particular user provides input to select an active element provided by the script of the content object 111, the script causes the browser 121 to send a content object event. The content object event indicates an event or action associated with the content indicated in the content object 111, based on the user input, for example rendering the content or causing other actions related to the content (e.g., identification determination). In various embodiments, the one or more active elements presented to the particular user in the browser 121, by the scripts provided in the content object 111, allow the particular user to perform one or more actions, such as rendering the theme content; rendering snippets of the play list; obtaining and rendering the complete content for one of the contents indicated in the playlist; pausing the rendering of the current content; stopping rendering of the current content; starting the rendering of the next content in the playlist; starting the rendering of the precious content indicated in the playlist, starting rendering the next content of the playlist in a particular category, starting rendering the content currently being rendered by the owner of the content object 111, requesting more information on the content, requesting supplemental content on the content, contacting the owner of the content object 111, or contacting a service provider to buy the content, among others, or some combination thereof.

In some embodiments, the content object event is sent from the browser 121 back to the web server 103, which forwards the content object event to the content object service 119. However, in other embodiments, the content object event is sent directly from the browser 121 to the content object service 119 or to other processes in the corresponding service 113. In some of these embodiments, the content object service 119 sends a notice of a content object event to the web server 103.

In response to receiving a content object event or notice thereof in step 1120, the web server 103 reports the content object event to the corresponding service 113 in step 1121. Thus a content object owner can determine from querying the service 113, how many times content from that owner's content object 111 has been rendered, or what content has been rendered, how often, what other actions have been taken, or what content has been bought, or some combination thereof. In some embodiments, no reporting is performed; and step 1121 is omitted.

In some embodiments, a modified HTTP message is formed in step 1123 based on the content object event or notice received in step 920. For example, a new web page is generated that shows only the icon of the content object whose content is being rendered, or the art or other metadata associates with the content is displayed. For example, in various embodiments, when an active element (e.g., a content play command) for a friend's content object 111 is selected by the particular user, the presentation of the content object is modified; e.g., the icon is highlighted, a pause button or stop button or next button or previous button or theme button or current button or buy button or contact button or supplemental content button or information button, or some combination thereof, is superimposed or added on the locket, or the image is changed to the cover art of the content being rendered. The modified presentation is indicated in the revised HTTP message formed in step 1123 and sent to the particular user's web browser in step 907. In some embodiments, all presentation changes associated with different actions available for the content object 111 are controlled by the scripts of the content object 111 and step 1123 is omitted.

In some embodiments, the web page presented to the particular user by the web browser provides an active element to edit or update the particular user's own content object 111, separate from the content object icons. Initial generation of a particular user's content object 111 can be performed this way. In such embodiments, the web server 103 receives an HTTP message that is not a content object event or notice thereof. In step 1125, it is determined whether such a message to create/edit/update a content object 111 is received, for example when the particular user wants to add or change the content object icon image or theme content (e.g., theme song) or remove one or more contents from the user's own playlist. If so, the updated content object information is obtained by the web server 103 and sent to the content object service 119 during step 1127 to update one or more values in the content object 111. In some embodiments, step 1127 involves presenting one or more web forms to the particular user to obtain the new or changed data. Web forms are well known in the art.

The web page is updated in step 1123 as a result of the input from the user; and sent to the particular user's web browser 121 in step 1107.

In step 1129, it is determined whether the process of supporting the content objects 111 should continue. If not, then the process ends. Otherwise, it is again determined in step 1120 and step 1125 whether a content object event or update is received. For example, when the web page receives no HTTP traffic for an extended period of time, e.g., 30 minutes, then it is determined in step 1129 to no longer continue, and the process ends.

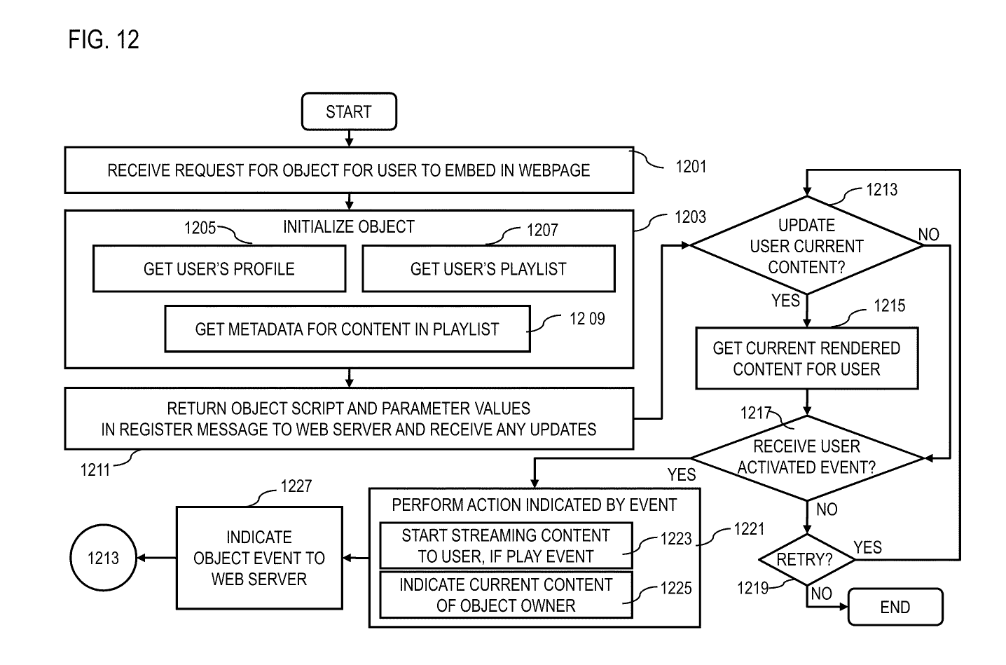

FIG. 12 is a flowchart of a process at a content object or content object service to provide and render shared content, according to one embodiment. In step 1201, a request for a content object 111 owned by a user is received from an application, such as the web page server 103 which will embed the content object 111 in a web page or a web page client that is rendering the web page with the content object 111. In other embodiments, the request is received from some other application, such as a client or server of an email service, audio or video playback application, game application, map application, or IM or a media services process.

In step 1203 the content object 111 is initialized. In some embodiments, step 1203 includes updating the data of the content object 111, for example, based on one or more messages from the particular user, e.g., through one or more HTTP forms. In the illustrated embodiment, step 1203 includes steps 1205, 1207 and 1209. In step 1205, the user profile is obtained. For example, a database command is issued to get the user profile for the particular user from the user account database 117 in service platform 101. In the illustrated embodiment, the user's profile includes a list of the user IDs of the particular user's friends, according to at least some social network site. Some other user profile data, included in various embodiments, are recited above.

In step 1207, the user's playlist is obtained. For example, a database command is issued to get the user playlist for the particular user from the corresponding service 113. In the illustrated embodiment, the user's playlists includes a list of content IDs for content rendered by the particular user.

In step 1209, at least some metadata for the content identified in the particular user's playlist is obtained. For example, a database command is issued to get the metadata for one or more contents indicated in the user playlist for the particular user. In some embodiments, the metadata from one or more of the services 113 on the network 107. In the illustrated embodiment, the metadata includes, for instance, links to cover art for content in the particular user's playlist.

Based on the data obtained, e.g., in steps 1205, 1207 and 1209, the content object 111 is constructed. In some embodiments, the user's profile or the user's playlist indicates the theme content (e.g., theme song) that represents the particular user's style for the content.

In step 1211, the content object 111 is returned to the process that requested the content object 111 in step 1201, such as the web server 103. In embodiments in which the process is performed by the content object 111 itself already in the webpage, step 1211 merely augments the data and scripts already in the content object 111.

In step 1213, it is determined whether it is time to periodically check the current content being rendered by the particular user. If so, then the currently rendered content for the user is obtained in step 1215. For example, a database command is issued to get the event data for the particular user from the corresponding service 113. This event data 138 indicates the previously and currently rendered content detected at the UE 105 of the owner of the content object 111. If not, step 1215 is skipped.

In step 1217, it is determined whether a message indicating a user activated content object event has been received. In some embodiments, the content object event is received at the content object 111 embedded in the user's application. In some embodiments, such a content object event message is sent in response to user input by the script installed in the user's web browser 121 or other application by the content object 111, as described above. In some embodiments, the content object event is sent to the content object service 119. In some embodiments, the event is sent first to the web server 103 and relayed by the web server 103 to the content object service 119. The event can be sent by the owner of the content object 111 or by a different user for whom the owner is a friend on a social network. If a user activated content object event is not received in step 1217, then it is determined in step 1219 whether to wait and retry receiving a message in a little while, by repeating steps 1213 and 1217. If no retries are attempted, then the process ends.

If it is determined in step 1217, that a message indicating a user activated content object event has been received, then the action indicated by the content object event is performed in step 1221. In the illustrated embodiment, step 1221 includes step 1223 and step 1225. In step 1223, the content indicated in a play event message is streamed to the user's web browser 121. This may be done directly from the content object 111 or content object service 119 using content in from the service 113, or indirectly through a content distribution network (CDN) service 970. Note that the user may be the owner of the content object 111 or a different user. If the user activated content object event indicates the content currently played by the content object 111 owner is desired by another user, then in step 1225, the content currently played is indicated to the user who activated the content object event. For example, the current content being played by the content object owner, as obtained in step 1215, is indicated in a message returned to the script process executing in the different user's browser 121.

In step 1227, the locket event received in step 1217 is indicated to the web server 103 or other application that requested the content object 111. In some embodiments, the web server 103 forwarded the user activated content object event and step 1227 is omitted. Control passes back to step 1213 and following steps to see if additional user activated content object events are received.

The processes described herein for updating a media profile may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

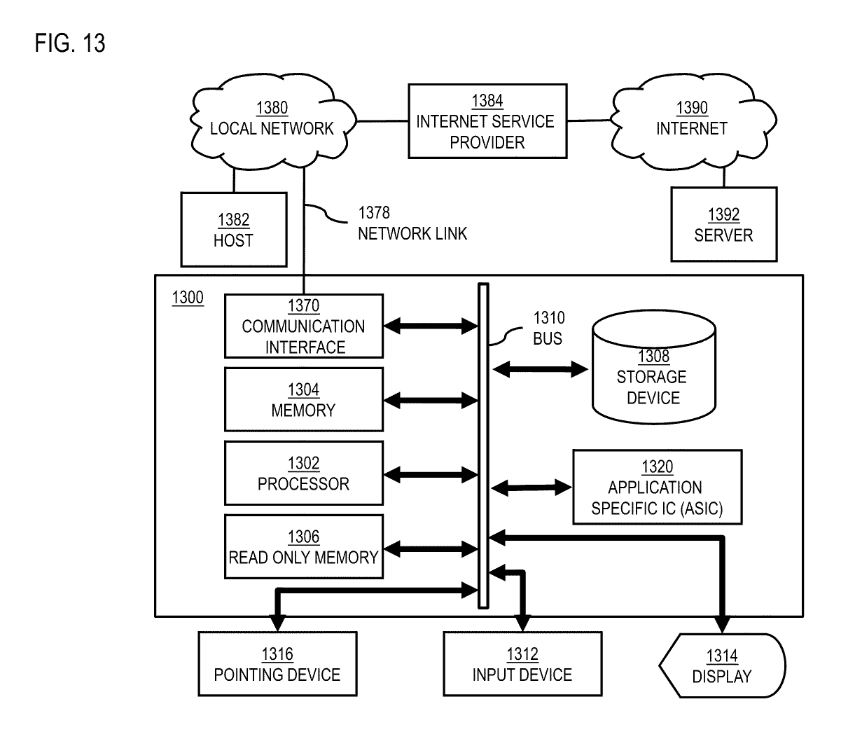

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to update a media profile as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of updating a media profile.

A bus 1310 includes one or more parallel conductors of information so that information is transferred quickly among devices coupled to the bus 1310. One or more processors 1302 for processing information are coupled with the bus 1310.

A processor 1302 performs a set of operations on information as specified by computer program code related to updating a media profile. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1300 also includes a memory 1304 coupled to bus 1310. The memory 1304, such as a random access memory (RAM) or other dynamic storage device, stores information including processor instructions for updating a media profile. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for updating a media profile, is provided to the bus 1310 for use by the processor from an external input device 1312, such as a keyboard containing alphanumeric keys operated by a human user, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT) or a liquid crystal display (LCD), or plasma screen or printer for presenting text or images, and a pointing device 1316, such as a mouse or a trackball or cursor direction keys, or motion sensor, for controlling a position of a small cursor image presented on the display 1314 and issuing commands associated with graphical elements presented on the display 1314. In some embodiments, for example, in embodiments in which the computer system 1300 performs all functions automatically without human input, one or more of external input device 1312, display device 1314 and pointing device 1316 is omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of application specific ICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 107 for updating a media profile to the UE 105.

The term “computer-readable medium” as used herein to refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer 1300, through Internet 1390, ISP equipment 1384, local network 1380 and communications interface 1370. The received code may be executed by processor 1302 as it is received, or may be stored in memory 1304 or in storage device 1308 or other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

FIG. 14 illustrates a chip set 1400 upon which an embodiment of the invention may be implemented. Chip set 1400 is programmed to update a media profile as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1400, or a portion thereof, constitutes a means for performing one or more steps of updating a media profile.

In one embodiment, the chip set 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to update a media profile. The memory 1405 also stores the data associated with or generated by the execution of the inventive steps.

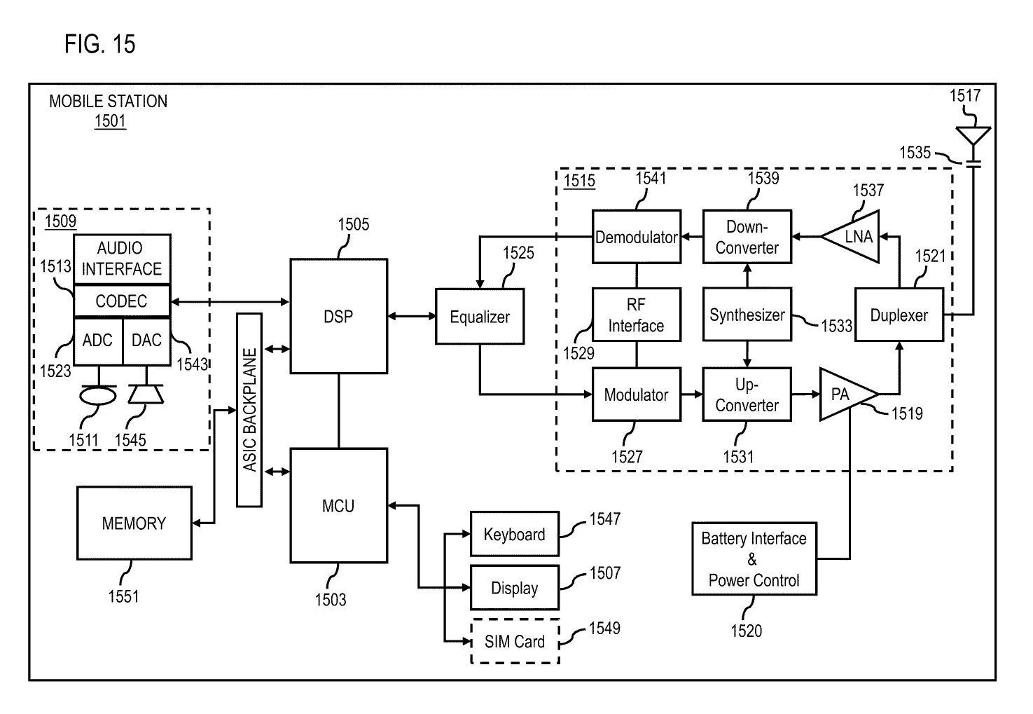

FIG. 15 is a diagram of exemplary components of a mobile terminal (e.g., handset) for communications, which is capable of operating in the system of FIG. 1, according to one embodiment. In some embodiments, mobile terminal 1500, or a portion thereof, constitutes a means for performing one or more steps of updating a media profile. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of updating a media profile. The display 15 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503—which can be implemented as a Central Processing Unit (CPU) (not shown).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to update a media profile. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including media data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request, from a device, to update a content object, wherein the content object includes a content playlist for expressing a content preference of a user of the device;
in response to the request, automatically retrieving information related to the content preference from the device and/or another device associated with the user; and
selecting one or more content items to include in the content playlist based on the retrieved content preference information.

2. A method of claim 1, wherein the content preference information includes information on content played on the device and/or the another device.

3. A method of claim 1, wherein the content preference information includes information related to the one or more content items, the method further comprising:
parsing the information to determine the one or more content items.

4. A method of claim 1, wherein the selecting includes:
weighting the content preference information by time, frequency of use, rating, or a combination thereof; and
selecting the one or more content items based at least in part on the weighted content preference information.

5. A method of claim 1, further comprising:
causing, at least in part, presentation of including the one or more content items in the content playlist.

6. A method of claim 5, wherein the presentation includes a graphical presentation, an audio presentation, a multimedia presentation, or a combination thereof.

7. A method of claim 1, further comprising:
receiving an input, from the device, for specifying the content preference information,
wherein the selecting of the one or more content items is based at least in part on the user-specified content preference information.

8. A method of claim 1, wherein the retrieving includes retrieving the content preference information from a social networking service.

9. An apparatus comprising:
at least one processor; and
at least one memory including computer program code,
the at least one memory and the computer program code configured to, with the at least one processor, cause the apparatus to perform at least the following,
receive a request, from a device, to update a content object, wherein the content object includes a content playlist for expressing a content preference of a user of the device,
in response to the request, automatically retrieve information related to the content preference from the device or another device associated with the user, and
select one or more content items to include in the content playlist based on the retrieved content preference information.

10. An apparatus of claim 9, wherein the content preference information includes information on content played on the device or the another device.

11. An apparatus of claim 10, wherein the content preference information includes information related to the one or more content items, and the apparatus is further caused to:
parse the information to determine the one or more content items.

12. An apparatus of claim 9, wherein when selecting the one or more content items, the apparatus is caused to
weight the content preference information by time, frequency of use, rating, or a combination thereof; and
select the one or more content items based at least in part on the weighted content preference information

13. An apparatus of claim 9, wherein the apparatus is further caused to:
cause, at least in part, presentation of including of the one or more content items in the content playlist

14. An apparatus of claim 15, wherein the presentation includes a graphical presentation, an audio presentation, a multimedia presentation, or a combination thereof.

15. An apparatus of claim 9, wherein the apparatus is further caused to:
receive an input, from the device, for specifying the content preference information,
wherein the selecting of the one or more content items is based at least in part on the user-specified content preference information.

16. An apparatus of claim 9, wherein when content preference information is retrieved, the apparatus is caused to retrieve the content preference information from a social networking service.

17. An apparatus of claim 9, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

18. A computer-readable storage medium carrying one or more sequences of one or more instructions which, when executed by one or more processors, cause an apparatus to at least perform the following steps:
receiving a request, from a device, to update a content object, wherein the content object includes a content playlist for expressing a content preference of a user of the device;
in response to the request, automatically retrieving information related to the content preference from the device or another device associated with the user; and
selecting one or more content items to include in the content playlist based on the retrieved content preference information.

19. A computer-readable storage medium of claim 18, wherein when selecting the one or more content items, the apparatus is caused to perform:
weighting the content preference information by time, frequency of use, rating, or a combination thereof; and
selecting the one or more content items based at least in part on the weighted content preference information.

20. A computer-readable storage medium of claim 18, wherein the apparatus is caused to further perform:
receiving an input, from the device, for specifying the content preference information,
wherein the selecting of the one or more content items is based at least in part on the user-specified content preference information.
